(19) United States
(12) Patent Application Publication
(10) Pub. No.: US 2019/0095768 A1
(43) Pub. Date: Mar. 28, 2019

(54) IMAGE FORMING APPARATUS AND IMAGE FORMING METHOD

(71) Applicants: KABUSHIKI KAISHA TOSHIBA, Tokyo (JP); TOSHIBA TEC KABUSHIKI KAISHA, Tokyo (JP)

(72) Inventor: Kazumasa Takada, Numazu Shizuoka (JP)

(21) Appl. No.: 15/712,569

(22) Filed: Sep. 22, 2017

(51) Int. Cl. G06K 15/12; G03G 15/30; H04N 1/12; H04N 1/047

(52) U.S. Cl. CPC G06K 15/1219; G03G 15/305; H04N 2201/04767; H04N 1/047; G06K 2215/0085; H04N 1/126

(57) ABSTRACT

In accordance with an embodiment, an image forming apparatus comprises a main scanning counter, a controller, and an interval determination section. The main scanning counter counts a first count value indicating the number of times a synchronization signal for synchronization between the apparatuses is input to itself, and registers the first count value to an initial value if a main scanning reference signal indicating a progress state of exposure in a main scanning direction is input to itself. The controller generates PreHSYNC generated at the same interval as the main scanning reference signal. The interval determination section determines that an abnormality occurs in the main scanning reference signal if the first count value satisfies a predetermined condition at a timing at which the PreHSYNC is input to itself.

### FIELD

Embodiments described herein relate generally to an image forming apparatus and an image forming method.

### BACKGROUND

In a conventional image forming apparatus, if a main scanning reference signal output from a LSU (Laser Scanning Unit) cannot be continuously detected for a certain time or more, the main scanning reference signal is determined to be abnormal. However, in the image forming apparatus, it is difficult to detect occurrence of abnormality and acquire a timing of occurrence of the abnormality if a period in which the abnormality occurs is short. Therefore, it is difficult to determine whether the abnormality of a printed image is caused by the abnormality of the main scanning reference signal or an abnormality other than the abnormality of the main scanning reference signal.

### DESCRIPTION OF THE DRAWINGS

FIG. 1 is an external view of an image forming apparatus;

FIG. 2 is a schematic diagram of a LSU;

FIG. 3 is a structural diagram illustrating a part of the outline of a controller;

FIG. 4 is a diagram illustrating functional components of a first error detection circuit;

FIG. 5 is a diagram illustrating functional components of a second error detection circuit;

FIG. 6 is a diagram illustrating a state of each signal if the LSU operates normally;

FIG. 7 is a diagram illustrating a state of each signal if the LSU does not operate normally according to the embodiment;

FIG. 8 is a diagram illustrating the relationship between VDEN and FCNT;

FIG. 9 is a flowchart illustrating the flow of a HSYNC error detection processing; and

FIG. 10 is a schematic diagram of a LSU.

### DETAILED DESCRIPTION

In accordance with an embodiment, an image forming apparatus comprises a main scanning counter, a controller, and an interval determination section. The main scanning counter counts a first count value indicating the number of times a synchronization signal for synchronization between the apparatuses is input to itself, and registers the first count value to an initial value if a main scanning reference signal indicating a progress state of exposure in a main scanning direction is input to itself. The controller generates PreHSYNC generated at the same interval as the main scanning reference signal. The interval determination section determines that an abnormality occurs in the main scanning reference signal if the first count value satisfies a predetermined condition at a timing at which the PreHSYNC is input to itself.

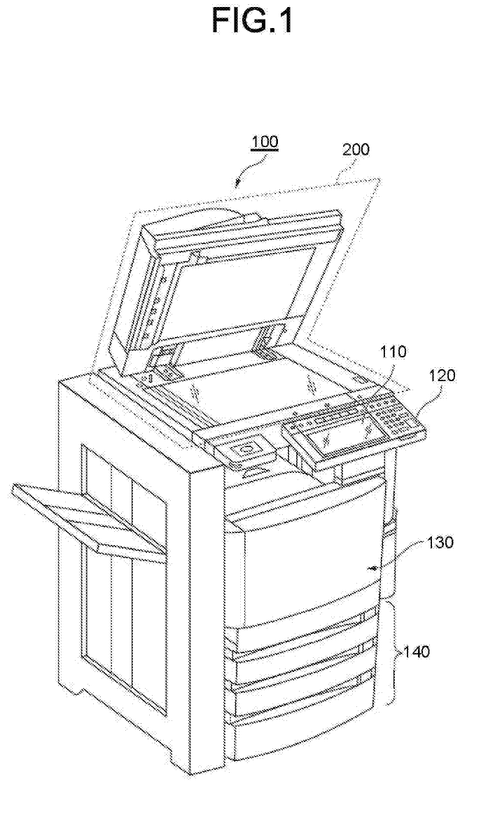

FIG. 1 is an external view exemplifying the overall constitution of an image forming apparatus 100 according to the embodiment. The image forming apparatus 100 is, for example, a multi-functional peripheral. The image forming apparatus 100 includes a display 110, a control panel 120, a printer section 130, a sheet housing section 140 and an image reading section 200. Furthermore, the printer section 130 of the image forming apparatus 100 is a device for fixing a toner image.

The image forming apparatus 100 forms an image on a sheet using a developer such as a toner. The sheet is, for example, a paper or a label paper. The sheet may be an optional object as long as the image forming apparatus 100 can form an image on a surface thereof.

The display 110 is an image display device such as a liquid crystal display, an organic EL (Electro Luminescence) display and the like. The display 110 displays various information relating to the image forming apparatus 100.

The control panel 120 includes a plurality of buttons. The control panel 120 receives an operation by a user. The control panel 120 outputs a signal in response to an operation executed by the user to a controller of the image forming apparatus 100. Furthermore, the display 110 and the control panel 120 may be constituted as an integrated touch panel.

The printer section 130 forms an image on the sheet based on image information generated by the image reading section 200 or image information received through a communication path. The printer section 130 forms an image through the following processing, for example. An image forming section of the printer section 130 forms an electrostatic latent image on a photoconductive drum based on the image information. The image forming section of the printer section 130 forms a visible image by attaching the developer to the electrostatic latent image. Toner is exemplified as a concrete example of the developer. A transfer section of the printer section 130 transfers the visible image onto the sheet. A fixing section of the printer section 130 fixes the visible image on the sheet by heating and pressurizing the sheet. The sheet on which the image is formed may be a sheet housed in the sheet housing section 140, or a sheet that is manually fed.

The sheet housing section 140 houses the sheet used in the printing by the printer section 130.

The image reading section 200 reads the image information which is a reading object as intensity of light. The image reading section 200 records the read image information. The recorded image information may be transmitted to another information processing apparatus via a network. The recorded image information may be printed on the sheet by the printer section 130.

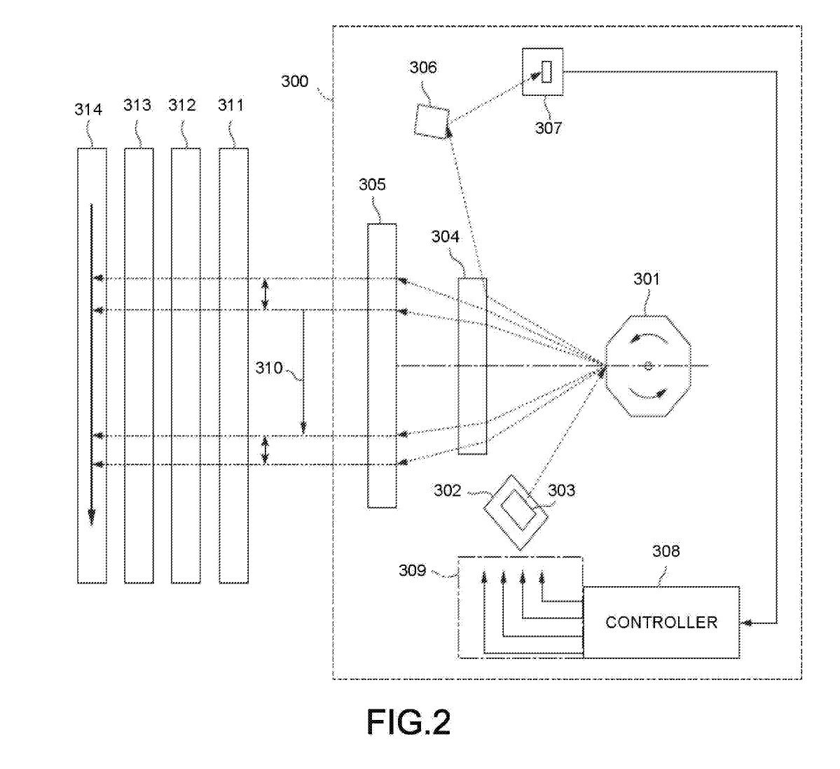

FIG. 2 is a schematic diagram of the LSU 300 performing image exposure using a polygon mirror according to the embodiment. LSU 300 performs the image exposure on the photoconductive drum. The LSU 300 includes a polygon mirror 301, a laser light emitting section 302, a laser diode 303, an Fθ1 lens 304, an Fθ2 lens 305, a mirror 306, and a BD (Beam Detect) sensor 307.

The polygon mirror 301 rotates counterclockwise. The polygon mirror 301 reflects laser light to the Fθ1 lens 304 by rotating. The laser light is output from the laser light emitting section 302. The laser light emitting section 302 outputs the laser light to the polygon mirror 301. The laser light emitting section 302 includes a laser diode 303. The laser diode 303 outputs the laser light to the polygon mirror 301.

The Fθ1 lens 304 refracts the incident laser light. The laser light refracted by the Fθ1 lens 304 is incident on the Fθ2 lens 305 and the mirror 306. The Fθ2 lens 305 refracts the incident laser light. The laser light refracted by the Fθ2 lens 305 is incident on a photoconductive drum K311, a photoconductive drum C312, a photoconductive drum M313 and a photoconductive drum Y314. An arrow 310 indicates a scanning direction of the laser light incident on each photoconductive drum.

The mirror 306 reflects the incident laser light to the BD sensor 307. If the laser light is incident, the BD sensor 307 outputs a BD signal to a controller 308.

The controller 308 controls the operation of each part of the LSU 300. The controller 308 is executed by, for example, an apparatus including a CPU (Central Processing Unit) and a RAM (Random Access Memory) for controlling the whole LSU 300. For example, the controller 308 is composed of an ASIC. For example, the controller 308 drives the polygon mirror 301. The controller 308 enables the laser light emitting section 302 to emit the laser light via a laser driver substrate, for example. An area 309 indicates the laser driver substrate.

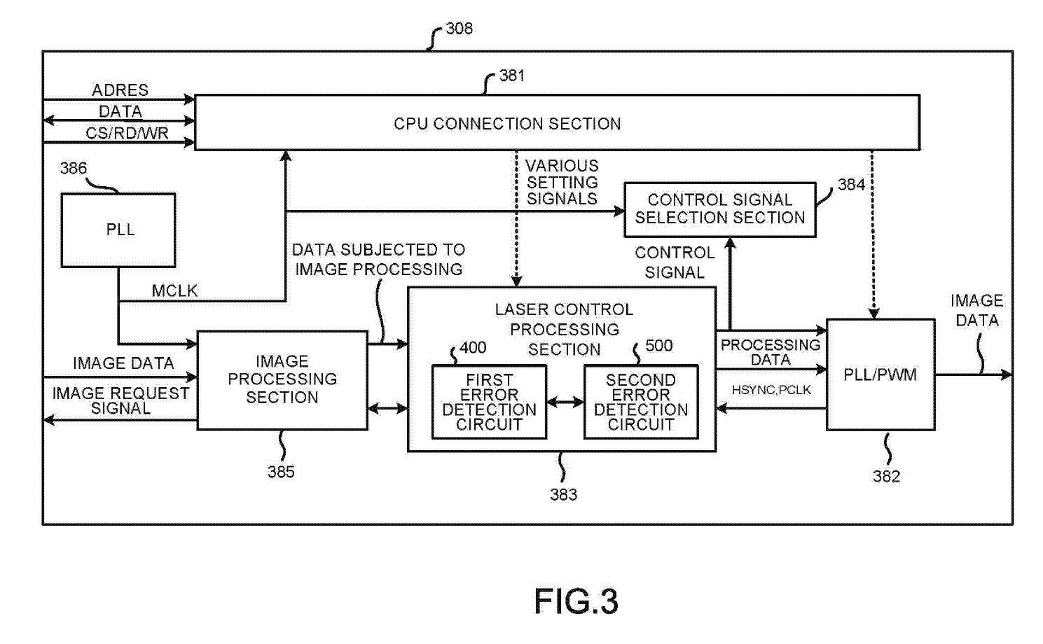

FIG. 3 is a structural diagram illustrating a part of the outline of the controller 308 controlling the laser light according to the embodiment. The controller 308 includes a CPU connection section 381, a PLL/PWM 382, a laser control processing section 383, a control signal selection section 384, an image processing section 385 and a PLL 386.

The CPU connection section 381 is an interface for connecting a CPU disposed outside the controller 308 with the controller 308. The CPU connection section 381 transmits and receives data to and from an external CPU. The CPU connection section 381 outputs various setting signals to the PLL/PWM 382 and the laser control processing section 383.

The PLL/PWM 382 outputs the image data to a laser driver substrate arranged outside the controller 308. The PLL/PWM 382 outputs the main scanning reference signal to the laser control processing section 383. The PLL/PWM 382 outputs PCLK to the laser control processing section 383. The main scanning reference signal is also called HSYNC. The main scanning reference signal is output according to a BD signal output by the BD sensor 307. The main scanning reference signal indicates a progress state of the exposure in the main scanning direction.

The laser control processing section 383 processes the image processing data received from the image processing section 385. The laser control processing section 383 outputs the processed processing data to the PLL/PWM 382. The laser control processing section 383 outputs a control signal to the control signal selection section 384 and the PLL/PWM 382. The laser control processing section 383 includes a first error detection circuit 400 and a second error detection circuit 500 for detecting errors of the HSNYC.

The image processing section 385 receives the image data from the outside of the controller 308. The image processing section 385 processes the image data to generate the image processing data. The image processing section 385 outputs the image processing data to the laser control processing section 383. The PLL 386 outputs MCLK to the CPU connection section 381, the control signal selection section 384 and the image processing section 385. The controller 308 may have a plurality of the PLL/PWM 382, the laser control processing sections 383 and the image processing sections 385.

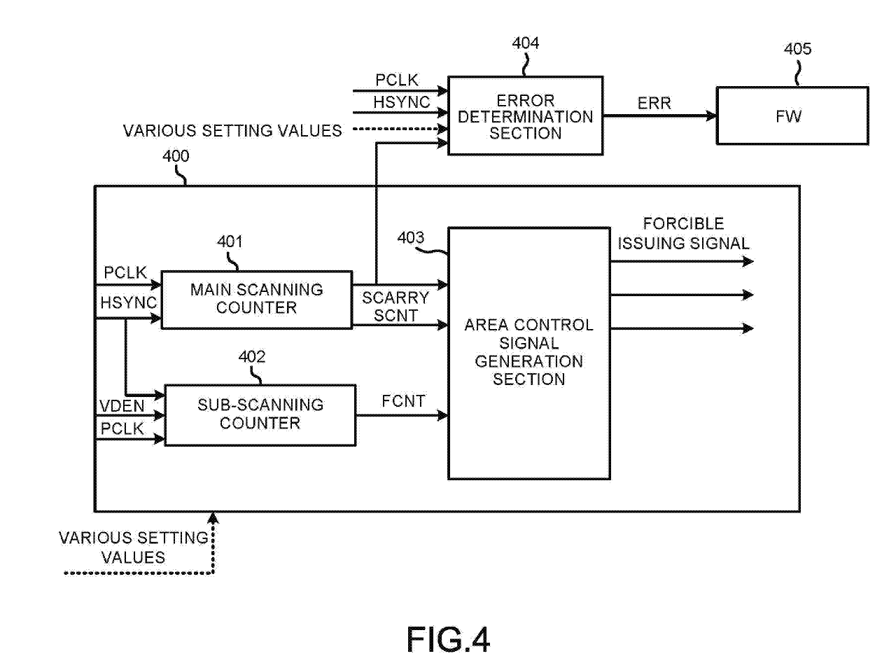

FIG. 4 is a diagram illustrating functional components of the first error detection circuit 400 that detects the error of HSYNC according to the embodiment. The first error detection circuit 400 includes a main scanning counter 401, a sub-scanning counter 402 and an area control signal generation section 403. The first error detection circuit 400 is connected to an error determination section 404 and a FW 405. The first error detection circuit 400, the error determination section 404 and the FW 405 are arranged inside the laser control processing section 383.

The main scanning counter 401 counts the number of input PCLK signals. The count value counted by the main scanning counter 401 is cleared by the input HSYNC. The clear refers to, for example, registering an initial value in the count value. The initial value is, for example, 0. The main scanning counter 401 outputs the count value to the area control signal generation section 403. The value counted by the main scanning counter 401 is also called SCNT. The SCNT is an example of a first count value. The PCLK is an example of a synchronization signal. The synchronization signal is a signal for synchronizing functions in the image forming apparatus 100.

The main scanning counter 401 outputs a main scanning carry signal to the area control signal generation section 403 and the error determination section 404 if counting is performed until a predetermined condition is satisfied. The main scanning counter 401 stops the counting if the main scanning carry signal is output. The predetermined condition refers to a case in which the counting is performed until a value larger than a cycle at which the HSYNC is input is counted. The large value may be, for example, 1.5 times the value counted according to the input cycle or the like. The main scanning carry signal is also called SCARRY.

The sub-scanning counter 402 counts the number of signals of the input HSYNC while the LSU 300 scans in a sub-scanning effective image area. The sub-scanning counter 402 outputs the count value to the area control signal generation section 403. The count value counted by the sub-scanning counter 402 is also referred to as FCNT. The count value counted by the sub-scanning counter 402 is cleared if the LSU 300 moves outside the sub-scanning effective image area. Specifically, if a sub-scanning effective signal is 0, the sub-scanning counter 402 counts the number of signals of the HSYNC while the LSU 300 scans the sub-scanning effective image area. If the sub-scanning effective signal is 1, the sub-scanning counter 402 registers the initial value in the count value while the LSU 300 moves outside the sub-scanning effective image area. The initial value is, for example, 0. The sub-scanning effective signal is also referred to as VDEN. The VDEN has OVDENO which is a signal indicating an effective image area including a margin area on the sheet and PVDENO which is a signal indicating the output image area which does not include the margin area on the sheet. In the present embodiment, it is assumed that VDEN refers to OVDENO.

In a case of receiving the main scanning carry signal, the area control signal generation section 403 outputs a forcible light emitting signal to detect the main scanning reference signal. The area control signal generation section 403 generates the forcible light emitting signal based on the main scanning counter. If the main scanning counter 401 stops counting, the area control signal generation section 403 outputs the forcible light emitting signal until the main scanning reference signal is input to the main scanning counter 401 and the initial value is registered in the count value.

In a case of receiving the main scanning carry signal, the error determination section 404 determines that the main scanning reference signal is not received. If the error determination section 404 determines that the main scanning reference signal is not received, the error determination section 404 outputs an HSYNC error signal. If the main scanning reference signal is input a predetermined number of times, the output of the HSYNC error signal is stopped. The predetermined number of times may be, for example, once or twice. The HSYNC error signal is also referred to as ERR.

The FW 405 polls the HSYNC error signal output by the error determination section 404 at predetermined intervals. The FW 405 determines that the abnormality occurs in the main scanning reference signal if the HSYNC error signal is asserted a predetermined number of times as a result of polling. The FW 405 generates a service call and stops the image forming apparatus 100. The predetermined interval may be, for example, 100 ms or 150 ms. The predetermined number of times may be, for example, ten times or fifteen times.

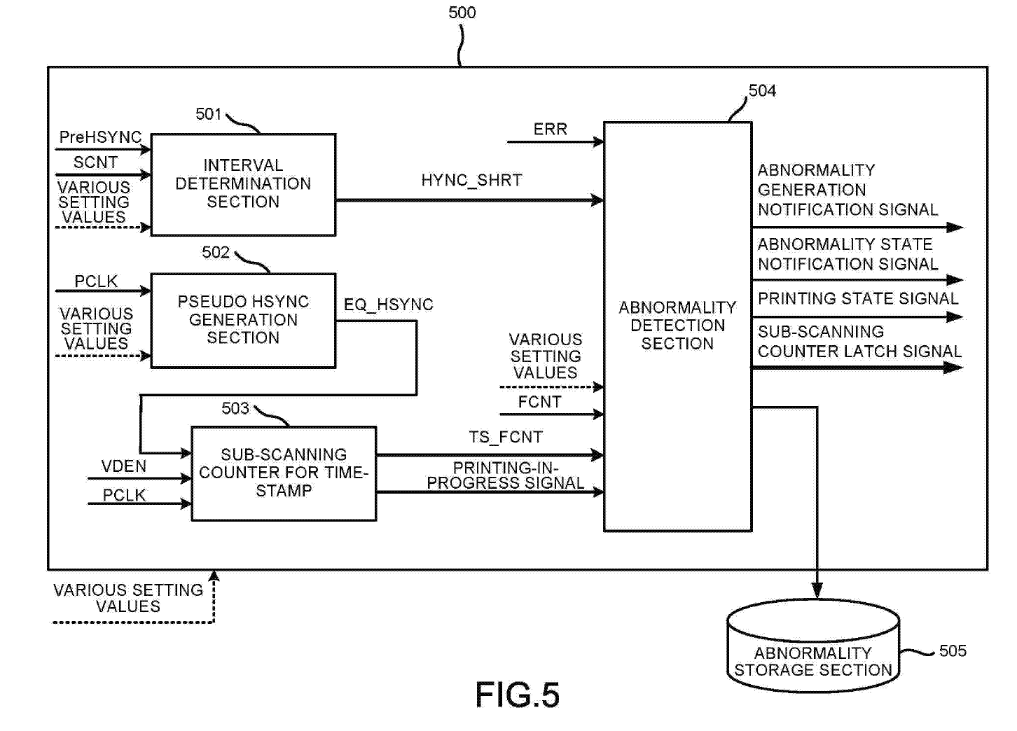

FIG. 5 is a diagram illustrating functional components of the second error detection circuit 500 that performs error detection of the HSYNC according to the embodiment. The second error detection circuit 500 includes an interval determination section 501, a pseudo HSYNC generation section 502, a sub-scanning counter for time-stamp 503, and an abnormality detection section 504. The second error detection circuit 500 is connected to an abnormality storage section 505. The second error detection circuit 500 and the abnormality storage section 505 are arranged inside the laser control processing section 383.

The interval determination section 501 determines whether or not the interval at which the main scanning reference signal is input is shorter than a preset interval. Specifically, the interval determination section 501 receives a signal (hereinafter referred to as “PreHSYNC”) input at the same interval as the BD signal. The PreHSYNC is input earlier than the main scanning reference signal by a predetermined interval. The predetermined interval depends on a processing capability of the laser control processing section 383, but usually it is required to be an interval of 3-4 CLK or longer. In the present embodiment, the HSYNC is input 16 CLK earlier than the main scanning reference signal. The PreHSYNC is generated by the laser control processing section 383. If the PreHSYNC is input, the interval determination section 501 compares the SCNT (SCNT not cleared by the HSYNC signal) at a timing at which the PreHSYNC is input with a preset value. The interval determination section 501 determines that the interval at which the HSYNC signal is input is shorter than a preset interval if the SCNT is smaller than the set value. If the interval determination section 501 determines that the interval at which the HSYNC signal is input is short, the interval determination section 501 outputs a short signal to the abnormality detection section 504. The short signal is also referred to as HSYNC_SHRT.

The pseudo HSYNC generation section 502 generates a pseudo signal (hereinafter, referred to as “EQ_HSYNC”) corresponding to the main scanning reference signal. The pseudo HSYNC generation section 502 generates the EQ_HSYNC at the same timing as the main scanning reference signal if the abnormality does not occur. The pseudo HSYNC generation section 502 outputs the EQ_HSYNC to the sub-scanning counter for time-stamp 503. If the abnormality occurs in the main scanning reference signal, the sub-scanning counter 402 stops counting or starts counting earlier than usual. Therefore, the sub-scanning counter 402 cannot measure the time at which the abnormality occurs. The pseudo HSYNC generation section 502 generates the EQ_HSYNC at certain intervals irrespective of the abnormality of the main scanning reference signal. The EQ_HSYNC is an example of a pseudo main scanning reference signal.

The sub-scanning counter for time-stamp 503 counts the EQ_HSYNC by starting with the assertion of the sub-scanning effective signal. The sub-scanning counter for time-stamp 503 outputs the count value to the abnormality detection section 504. The sub-scanning counter for time-stamp 503 clears the counted count value at a timing at which the VDEN indicating the sub-scanning printing effectiveness changes from 0 to 1. The sub-scanning counter for time-stamp 503 outputs a signal (hereinafter referred to as “printing-in-progress signal”) indicating whether or not printing is being performed (VDEN is being asserted) to the abnormality detection section 504 together with the current count value. Therefore, the sub-scanning counter for time-stamp 503 can acquire the timing at which the abnormality occurs in the main scanning reference signal. The value counted by the sub-scanning counter for time-stamp 503 is also referred to as TS_FCNT. The TS_FCNT is an example of a second count value. The second count value indicates the number of times EQ_HSYNC is input to itself.

The abnormality detection section 504 latches TS_FCNT if the interval at which the main scanning reference signal is input satisfies a predetermined condition. The abnormality detection section 504 outputs a message indicating that the predetermined condition is satisfied to the FW 405. The predetermined condition is, for example, a case in which the interval at which the main scanning reference signal is input is different from the preset interval. The abnormality detection section 504 latches the TS FCNT if the HSYNC SHRT is input. The abnormality detection section 504 latches the TS_FCNT if the ERR is input. The abnormality detection section 504 latches the TS_FCNT if the input of the HSYNC_SHRT or the ERR is stopped. The interval determination section 501 may stop the HSYNC_SHRT if the SCNT becomes equal to or greater than a predetermined value. If the interval at which the main scanning reference signal is input is short, the abnormality detection section 504 stores the TS_FCNT, an error type, and presence/absence of the printing-in-progress signal in the abnormality storage section 505.

Therefore, the abnormality detection section 504 can notify that the respective signals change and the latched value in such a manner that the change or the latched value can be recognized by the FW 405.

The abnormality storage section 505 is constituted using a storage device such as a magnetic hard disk device or a semiconductor storage device. The abnormality storage section 505 stores values of the TS_FCNT, the error type and the printing-in-progress signal. The error type is, for example, a case in which the interval at which the main scanning reference signal is input is shorter than the preset interval, a case in which the interval at which the main scanning reference signal is input is longer than the preset interval, a case in which it is short, or a case of returning to the preset interval from the case in which the interval at which the main scanning reference signal is input is shorter or longer.

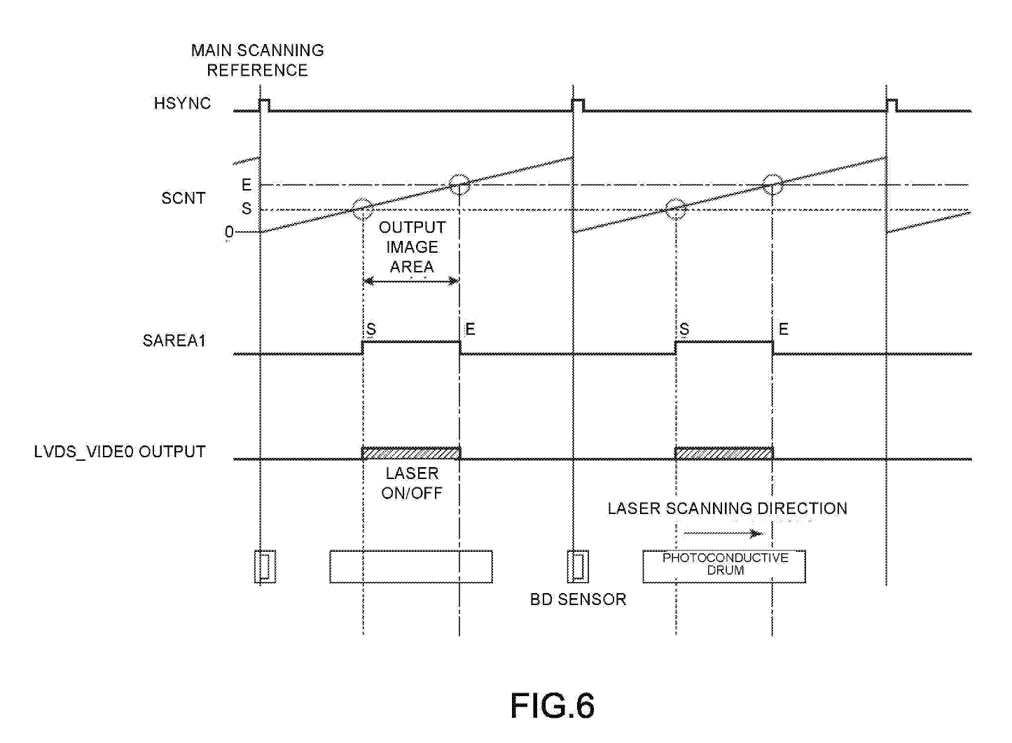

FIG. 6 is a diagram illustrating the state of each signal if the LSU 300 operates normally according to the embodiment. A horizontal axis represents the passage of time. A vertical axis represents values of the HSYNC, the SCNT, SAREA 1 and the LVDS_VIDEO.

According to FIG. 6, a main scanning reference is the timing at which the HSYNC is input. If the HSYNC is input, the SCNT is set to 0. After that, the SCNT increases with the passage of time. In the SAREA 1 and LVDS_VIDEO output, if the scanning by the LSU 300 reaches the output image area, the output is switched. Thereafter, if the scanning by the LSU 300 separates from the output image area, the output is switched. If the scanning by the LSU 300 is completed, the HSYNC is input and the SCNT is cleared to 0.

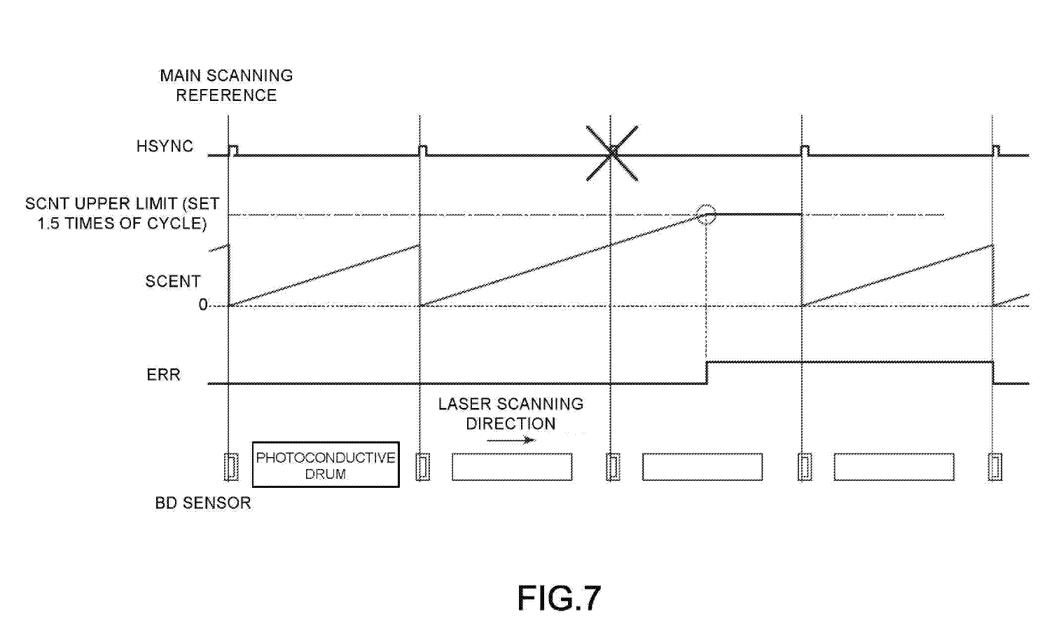

FIG. 7 is a diagram illustrating the state of each signal if the LSU 300 does not operate normally according to the embodiment. A horizontal axis represents the passage of time. A vertical axis represents values of the HSYNC, the SCNT and the ERR. In FIG. 7, a SCNT upper limit is set to a value 1.5 times the cycle counted according to the cycle in which the HSYNC is input. In FIG. 7, the error determination section 404 stops the ERR if the HSYNC is input twice.

The main scanning reference is the timing at which the HSYNC is input. If the HSYNC is input, the SCNT is cleared to 0. After that, the SCNT increases with the passage of time. In FIG. 7, the HSYNC is not input at the timing at which the HSYNC is input at the three times. Therefore, the SCNT is not cleared to 0 and the main scanning counter 401 continues the counting.

If the main scanning counter 401 counts up to the SCNT upper limit, the main scanning counter 401 stops the counting. The main scanning counter 401 outputs the main scanning carry signal if the SCNT upper limit is reached. The error determination section 404 outputs the ERR if the main scanning carry signal is output.

According to FIG. 7, the HSYNC is normally input at a timing at which the HSYNC is input at the fourth times. Therefore, the SCNT is cleared to 0. The error determination section 404 stops the output of the ERR at the timing at which the HSYNC is input twice after the error determination section 404 outputs the ERR.

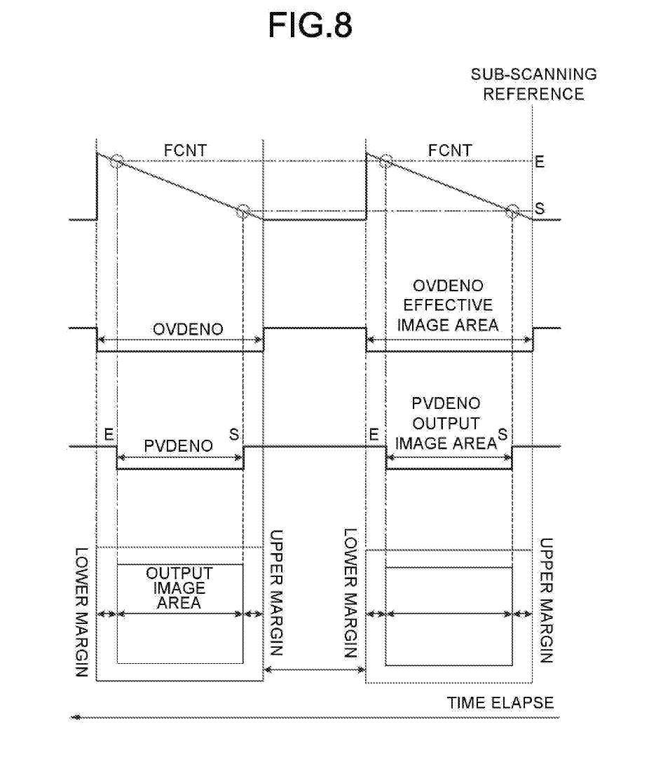

FIG. 8 is a diagram illustrating the relationship between the VDEN and the FCNT according to the embodiment. A horizontal axis represents the passage of time. The time elapses along an arrow direction recorded at the bottom in FIG. 8. The vertical axis represents values of the FCNT, the OVDENO and the PVDENO. The OVDENO is 0 if the LSU 300 scans the sheet (effective image area). The OVDENO is 1 if the LSU 300 scans the outside of the sheet. The PVDENO is 0 if the LSU 300 scans the image (output image area). The PVDENO is 1 if the LSU 300 scans the outside of the image. If the OVDENO is 0, the sub-scanning counter 402 counts the number of signals of the HSYNC assuming that the LSU 300 performs scanning within the sub-scanning effective image area. If the OVDENO is 1, the sub-scanning counter 402 registers the initial value in the count value on the assumption that the LSU 300 performs scanning at the outside of the sub-scanning effective image area.

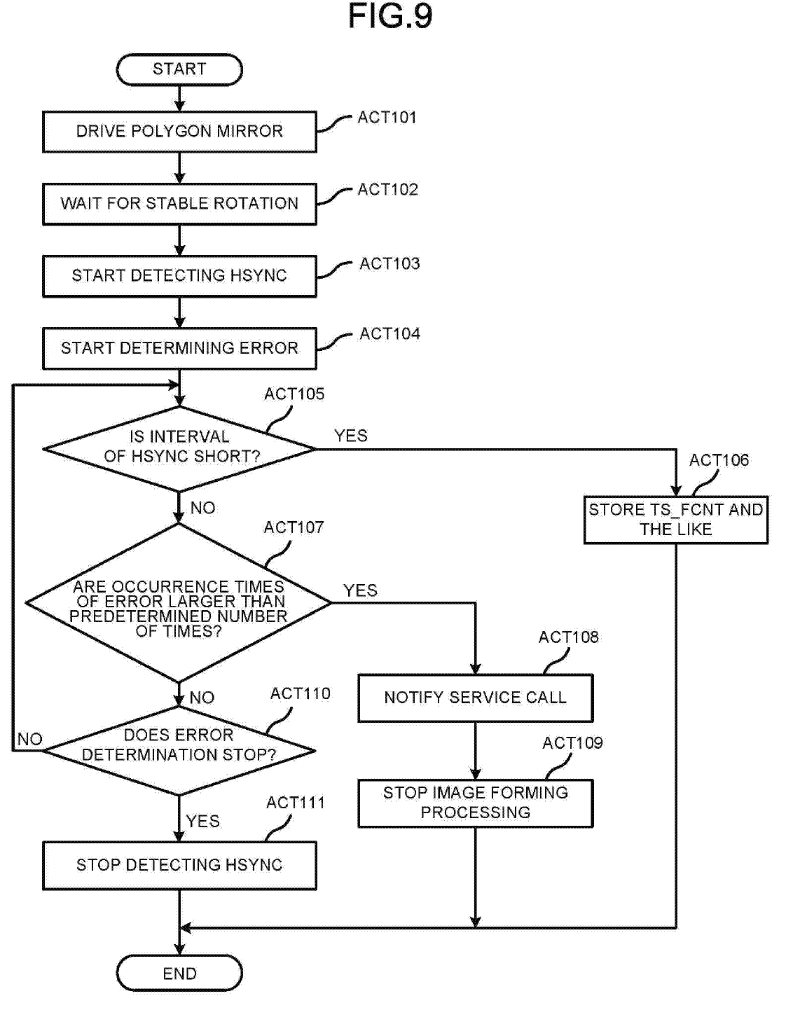

FIG. 9 is a flowchart illustrating the flow of an error detection processing of the HSYNC according to the embodiment. The controller 308 of the LSU 300 rotationally drives the polygon mirror 301 (ACT 101). The controller 308 waits until the rotation of the polygon mirror 301 is stabilized (ACT 102). The laser control processing section 383 starts detection of the HSYNC (ACT 103). The error determination section 404 starts to determine the error of the HSYNC (ACT 104).

The abnormality detection section 504 determines whether or not the interval at which the HSYNC is input is shorter than the predetermined interval (ACT 105). If the interval at which the HSYNC is input is shorter than a predetermined interval (Yes in ACT 105), the abnormality detection section 504 stores the TS_FCNT, the error type, and the presence or absence of the printing-in-progress signal in the abnormality storage section 505 (ACT 106).

If the interval at which the HSYNC is input is not shorter than the predetermined interval (No in ACT 105), the abnormality detection section 504 determines whether or not the interval at which the HSYNC is input satisfies a predetermined condition (ACT 107). The predetermined condition is, for example, a case in which the HSYNC error signal is asserted more than a pre-designated number of times.

If the interval at which the HSYNC is input satisfies a predetermined condition (Yes in ACT 107), the FW 405 generates the service call (ACT 108). The controller 308 stops the image forming processing by the image forming apparatus 100 (ACT 109).

If the interval at which the HSYNC is input does not satisfy the predetermined condition (No in ACT 107), the controller 308 determines whether or not the image forming processing is ended (ACT 110). If the image forming process is not ended (No in ACT 110), the controller 308 proceeds to the processing in ACT 105. If the image formation processing is ended (Yes in ACT 110), the laser control processing section 383 ends the detection of HSYNC (ACT 111).

In the image forming apparatus 100 constituted as described above, the interval determination section 501 compares the SCNT at the timing at which the PreHSYNC is input with the preset value. The interval determination section 501 outputs the HSYNC_SHRT to the abnormality detection section 504 if the SCNT is determined to be short. Therefore, the abnormality that the main scanning reference signal is input at an interval shorter than the predetermined time can be detected. The abnormality detection section 504 latches the TS_FCNT if the HSYNC_SHRT is input. Therefore, it is also possible to detect the timing at which the abnormality relating to the main scanning reference signal occurs.

### <Modification>

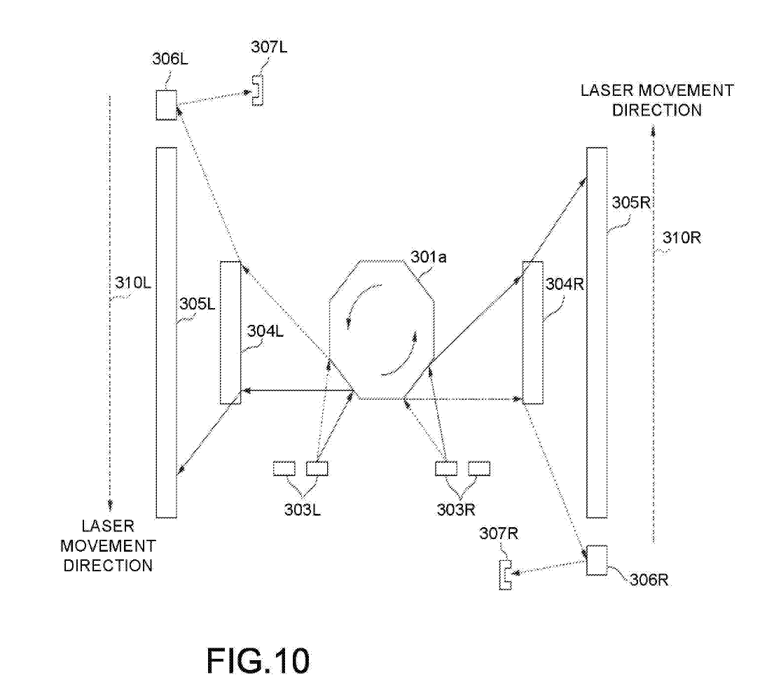

FIG. 10 is a schematic diagram of a LSU 300a that performs image exposure using a polygon mirror if laser is irradiated from two directions. The LSU 300a performs the image exposure on the photoconductive member. The LSU 300a includes a polygon mirror 301a, laser diodes 303L, laser diodes 303R, an Fθ1 lens 304L, an Fθ2 lens 305L, an Fθ1 lens 304R, an Fθ2 lens 305R, a mirror 306L, a mirror 306R, a BD sensor 307L, and a BD sensor 307R.

The polygon mirror 301a rotates counterclockwise. The polygon mirror 301a reflects laser light incident from the laser diode 303L to the Fθ1 lens 304L by rotating. The Fθ1 lens 304L refracts the incident laser light. The laser light refracted by the Fθ1 lens 304L is incident on the Fθ2 lens 305L and the mirror 306L. An arrow 310L indicates a scanning direction of the laser light incident on the photoconductive drum. The mirror 306L reflects the incident laser light to the BD sensor 307L. If the laser light is incident, the BD sensor 307L outputs a BD signal to the controller.

The polygon mirror 301a reflects laser light incident from the laser diodes 303R to the Fθ1 lens 304R by rotating. The Fθ1 lens 304R refracts the incident laser light. The laser light refracted by the Fθ1 lens 304R is incident on the Fθ2 lens 305R and the mirror 306R. An arrow 310R indicates scanning direction of the laser light incident on the photoconductive drum. The mirror 306R reflects the incident laser light to the BD sensor 307R. If the laser light is incident, the BD sensor 307R outputs a BD signal to the controller.

As described above, the LSU according to the embodiment may also be used for a polygon mirror irradiated with the laser from two directions.

While certain embodiments have been described these embodiments have been presented by way of example only, and are not intended to limit the scope of the inventions . Indeed, the novel embodiments described herein may be embodied in a variety of other forms: furthermore various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An image forming apparatus, comprising:
a main scanning counter configured to count a first count value indicating the number of times a synchronization signal to synchronize the timing between the apparatuses, and register the first count value to an initial value if a main scanning reference signal indicating a progress state of exposure in a main scanning direction;
a controller configured to generate a pre-main scanning reference signal generated at the same interval as the main scanning reference signal; and
an interval determination section configured to determine that an abnormality occurs in the main scanning reference signal if the first count value satisfies a predetermined condition at a timing at which the pre-main scanning reference signal is input to itself.

2. The image forming apparatus according to claim 1, further comprising:
a pseudo main scanning reference signal generation section configured to generate a pseudo main scanning reference signal input at the same timing as the main scanning reference signal if the abnormality does not occur;
a sub-scanning counter for time-stamp configured to count a second count value indicating the number of times the pseudo main scanning reference signal is input thereto;
an abnormality storage section configured to store a content of the abnormality and the second count value; and
an abnormality detection section configured to store the content of the abnormality and the second count value in the abnormality storage section if it is determined that the abnormality occurs in the main scanning reference signal.

3. The image forming apparatus according to claim 2, wherein
the interval determination section determines that the abnormality occurs in the main scanning reference signal if the first count value is smaller than a predetermined value and generates a short signal indicating that the main scanning reference signal is shorter than a predetermined interval.

4. The image forming apparatus according to claim 3, wherein
the interval determination section stops generation of the short signal if the first count value is equal to or greater than the predetermined value.

5. The image forming apparatus according to claim 1, wherein
the controller generates the pre-main scanning reference signal a predetermined time earlier than the main scanning reference signal.

6. The image forming apparatus according to claim 2, further comprising:
an error determination section configured to generate an error signal indicating that the abnormality occurs in the main scanning reference signal if a main scanning carry indicating that the first count value is counted up to a predetermined value is input, wherein
the abnormality detection section stores that the first count value is counted up to the predetermined value and the second count value in the abnormality storage section if the error signal is input.

7. The image forming apparatus according to claim 2, wherein
the sub-scanning counter for time-stamp returns the second count value to the initial value if a signal relating to printing in a sub-scanning direction satisfies a predetermined condition.

8. The image forming apparatus according to claim 6, wherein
the error determination section stops generating the error signal if the main scanning reference signal is input a predetermined number of times after the error signal is generated.

9. The image forming apparatus according to claim 8, wherein
the abnormality detection section stores that the input of the error signal is stopped and the second count value in the abnormality storage section if the input of the error signal is stopped.

10. An image forming method by an image forming apparatus, including:
counting a first count value indicating the number of times a synchronization signal to synchronize a timing between the apparatuses, and registering the first count value to an initial value if a main scanning reference signal indicating a progress state of exposure in a main scanning direction;
generating a pre-main scanning reference signal generated at the same interval as the main scanning reference signal; and
determining that an abnormality occurs in the main scanning reference signal if the first count value satisfies a predetermined condition at a timing at which the pre-main scanning reference signal is input thereto.
